(19) United States
(12) Patent Application Publication
(10) Pub. No.: US 2018/0362896 A1
(43) Pub. Date: Dec. 20, 2018

(54) PERFUME DELIVERY AGGREGATES

(71) Applicant: The Procter & Gamble Company, Cincinnati, OH (US)

(72) Inventors: Marco PERFETTI, Naples (IT); Giulia Ottavia BIANCHETTI, Brussels (BE); Luigi PADUANO, Naples (IT); Gerardino D'ERRICO, Florence (IT)

(21) Appl. No.: 16/005,733

(22) Filed: Jun. 12, 2018

(30) Foreign Application Priority Data
Jun. 19, 2017 (EP) 17176684.3
Jan. 12, 2018 (EP) 18151322.7

(51) Int. Cl. C11D 3/50; C11D 3/04; C11D 3/20; C11D 3/37

(52) U.S. Cl. CPC C11D 3/50; C11D 3/3753; C11D 3/201; C11D 3/046

(57) ABSTRACT

The present invention relates to liquid fabric care compositions obtained by a process comprising the steps of preparing an aqueous salt solution; preparing a perfume solution by mixing a perfume with an alcohol. The present invention further relates to a process of making a liquid fabric care composition and the use of a liquid fabric care composition to provide a pleasant smell to fabrics.

### FIELD OF INVENTION

The present application relates to liquid fabric care compositions comprising perfume delivery aggregates, and processes for making and uses of such compositions.

### BACKGROUND OF THE INVENTION

Liquid fabric care compositions used in the laundry process provide benefits to fabrics such as providing a pleasant smell. Such pleasant smell is provided by perfumes. A problem in the field is that much of the perfume is either not deposited or rinsed away during fabric treatment. Because perfumes are expensive components, encapsulation can be used in order to improve the delivery of the perfume during use. Unfortunately, encapsulation processes are time consuming and expensive as they typically require chemical reactions such as extensive crosslinking and/or result in capsules that over-protect the perfume as such capsules typically require a high energy input to release their active—for example pressure, temperature and/or electromagnetic radiation. Furthermore, such encapsulates' shell typically only protects the benefit agent and, on its own, provides no active value and may even leave a residue when a product containing the encapsulate is used.

Hence a need remains for liquid fabric care compositions comprising a perfume delivery means wherein the perfume delivery means can be formed without a crosslinked reaction or other complex chemical processes to improve the efficiency of deposition and/or retention of perfume onto fabrics, and/or improve release of perfume from said treated fabrics.

What is furthermore desired is a delivery means which is formed even when little energy is provided to the system, for example when only low shear mixing, needed to ensure homogeneous distribution of the perfume delivery means throughout the composition, is provided. Such liquid fabric care compositions comprising perfume delivery means and methods of making and using same are provided herein.

WO 2014/075956 A1 relates to improved deposition and reduced leakage from a particle comprising a core comprising a benefit agent and a shell wherein the shell comprises a crosslinked, hydrophobically modified polyvinyl alcohol, which comprises a crosslinking agent comprising dextran aldehydes. US4209417A relates to perfumed particles consisting essentially of water insoluble perfume, a water-soluble polymer and an emulsifier wherein the particles have particle size of 40-1400 microns. U.S. Pat. No. 4,891,389 relates to solid gel dispensers for achieving controlled release of volatile liquid materials wherein the dispenser contains a hydrogel formed from an aqueous solution of polyvinyl alcohol wherein the hydrogel comprises of from 1 to 20 percent of a polyelectrolyte. U.S. Pat. No. 5,460,817 relates to a particulate composition that comprises particles having an anhydrous core comprising a solid matrix polymer and an active ingredient distributed throughout the solid matrix polymer and an outer protective coacervated polymer shell.

### SUMMARY OF THE INVENTION

The present invention relates to liquid fabric care compositions obtained by a process comprising the steps of preparing an aqueous salt solution; preparing a perfume solution by mixing a perfume with an alcohol; preparing an aggregate dispersion by adding a polymer to the salt solution; mixing the aggregate dispersion with the perfume solution to obtain the liquid fabric care composition. Said salt is present at a level of from 1% to 15% by weight of the liquid fabric care composition and said salt is selected from the group consisting of alkaline metals salts, alkaline earth metal salts of the mineral acids, and combinations thereof. Said alcohol is present at a level of from 10% to 40% by weight of the liquid fabric care composition and the alcohol comprises from 1 to 7 carbons. Said polymer is present at a level of from 0.1% to 10% by weight of the liquid fabric care composition and the polymer is non-crosslinked and the polymer comprises vinylalcohol units. Said perfume is present at a level of from 0.01% to 2.0% by weight of the liquid fabric care composition. The present invention further relates to a process of making a liquid fabric care composition and the use of a liquid fabric care composition to provide a pleasant smell to fabrics.

### DETAILED DESCRIPTION OF THE INVENTION

### Definitions

As used herein, the term “aggregate” is to be understood to be aggregates of colloidal soft matter.

As used herein, the articles including “a” and “an” when used in a claim, are understood to mean one or more of what is claimed or described.

As used herein, the terms “include”, “includes” and “including” are meant to be non-limiting.

The test methods disclosed in the Test Methods Section of the present application should be used to determine the respective values of the parameters of Applicants' inventions.

Unless otherwise noted, all component or composition levels are in reference to the active portion of that component or composition, and are exclusive of impurities, for example, residual solvents or by-products, which may be present in commercially available sources of such components or compositions.

All measurements are performed at 25° C. unless otherwise specified.

All percentages and ratios are calculated by weight unless otherwise indicated. All percentages and ratios are calculated based on the total composition unless otherwise indicated.

Liquid Fabric Care Compositions

As used herein, the term “liquid fabric care composition” includes fabric softening compositions, fabric enhancing compositions, fabric freshening compositions, fabric cleaning compositions, and combinations thereof. The composition can include solids or gases in suitably subdivided form, but the overall composition excludes product forms which are non-liquid overall, such as tablets, powders, beads, non-liquid gels, or granules. The term “liquid” within “liquid fabric care composition” is to be understood as limiting to compositions having a viscosity of less than 10 Pa·s measured at a shear rate of 10/s.

Water can be present in the liquid fabric care compositions at a level of from 5% to 97%, preferably from 50% to 96%, more preferably from 70% to 95% by weight of the liquid care composition.

Polymer is present in the liquid fabric care composition at a level of from 0.1% to 7.5%, preferably of from 0.3% to 5%, more preferably of from 0.5% to 1% by weight of the liquid fabric care composition, wherein the polymer is non-crosslinked and the polymer comprises vinylalcohol units.

Salt is present in the liquid fabric care composition at a level of from 1% to 15%, preferably of from 3% to 13%, more preferably of from 4% to 11% by weight of the liquid fabric care composition. The salt is selected from a group consisting of alkaline metals salts, alkaline earth metal salts of the mineral acids, and combinations thereof.

Perfume is present in the liquid fabric care composition a level of from 0.01% to 2%, preferably of from 0.03% to 1%, more preferably of from 0.05% to 0.5% by weight of the liquid fabric care composition.

The liquid fabric care composition can be obtained by the process herein described.

Process of Making a Liquid Fabric Care Compositions

Liquid fabric care compositions of the present invention can be prepared in a process comprising the steps:
a. preparing an aqueous salt solution;
b. preparing a perfume solution by mixing a perfume with an alcohol;
c. preparing a polymer solution by mixing a polymer with water;
d. preparing an aggregate dispersion by adding the polymer solution to the salt solution;
e. mixing the aggregate dispersion with the perfume solution;
f. optionally introducing adjunct materials.

Step a: Preparing an Aqueous Salt Solution

An aqueous salt solution can be prepared by disolving salt into water. The aqueous salt solution comprises from 2% to 25% of salt by weight of the aqueous salt solution wherein the salt is selected from a group consisting of alkaline metals salts, alkaline earth metal salts of the mineral acids, and combinations thereof.

The aqueous salt solution may contain salt comprising a cation and an anion wherein the cation is selected from a list consisting of Li⁺, Na⁺, K⁺ Ca^{2 +}, Mg²⁺; and the anion is selected from a list consisting of Cl⁻, I⁻, Br⁻, SO₄²⁻. Preferably the salt is selected from a list consisting of NaCl, KCl, LiCl, CaCl₂, MgCl₂; more preferably the salt is NaCl.

The salt in the aqueous salt solution may be present at a level from 5% to 23%, preferably from 8% to 21% by weight of the aqueous solution.

Step b: Preparing a Perfume Solution by Mixing a Perfume with an Alcohol

A perfume solution can be prepared by mixing from 0.02% to 4% of perfume, by weight of the perfume solution, with an alcohol wherein the alcohol is selected from methanol, ethanol, propanol, isopropanol, preferably the alcohol is ethanol. The alcohol has been found to effectively solubilize the perfume and to reduce coalescence of the aggregates in the liquid fabric care composition. Hence, the alcohol improves the phase stability of the liquid fabric care composition.

The perfume of the perfume solution comprises one or more perfume raw materials (PRM). Perfume raw materials are the individual chemical compounds that are used to make a perfume composition. The choice of type and number of perfume raw materials is dependent upon the final desired scent. In the context of the present invention, any suitable perfume composition may be used. Those skilled in the art will recognize suitable compatible perfume raw materials for use in the perfume composition, and will know how to select combinations of ingredients to achieve desired scents.

The perfume resides at least partially in the perfume delivery aggregates in the liquid fabric care composition of the invention.

The perfume solution comprises perfume at a level of from 0.02% to 4%, preferably from 0.05% to 2.5%, more preferably from 0.08% to 1.0%, by weight of the perfume solution.

Preferred perfume solutions comprise perfume comprising linalool and/or 1-(2-tert-butylcyclohexyl)oxybutan-2-ol.

Step c: Preparing a Polymer Solution by Mixing a Polymer with Water

A polymer solution can be prepared by mixing a polymer with water wherein the polymer is non-crosslinked and the polymer comprises vinylalcohol units. Preferred polymers are polyvinylalcohol or polyethylenevinylalcohol polymers. The absence of cross-linking in the polymer improves the biodegradability of the aggregates in the liquid fabric care composition. The weight average molecular weight of the polymer as determined by Static Light Scattering (see Methods) is from 10,000 to 200,000 g/mol. Smaller molecular weight requires high polymer concentration for the aggregate preparation which is not cost-efficient, whereas higher molecular weight leads to a too fast aggregation process which is difficult to control and can lead to phase instabilities of the liquid fabric care composition.

The polymer in the polymer solution is present at a level of from 0.5% to 8%, preferably from 0.7% to 6%, even more preferably from 1% to 4% by weight of the polymer solution.

Commercial examples of suitable polymers are fully hydrolyzed polyvinylalcohol (Sigma Aldrich), highly hydrolized polyethylenevinylalcohol (Kuraray AQ4104) or super hydrolyzed polyethylenevinylalcohol (Kuraray HR3010).

Step d: Preparing an Aggregate Dispersion by Mixing the Polymer Solution with the Salt Solution

An aggregate dispersion can be prepared by adding the polymer solution of step c with the salt solution of step a. Aggregates are formed as the salt is brought in contact with the polymer during mixing through the salting-out mechanism.

Step e: Mixing the Aggregate Dispersion with the Perfume Solution

A liquid fabric care composition can be obtained when the aggregate dispersion is mixed with the perfume solution. As the aggregates act as recipients for the perfume, the resulting perfume delivery aggregate improves deposition and/or release onto fabrics of the perfume, at least partially, entrapped in the aggregate after treating fabrics with the liquid fabric care compositions.

Step f: Optionally Introducing Adjunct Materials

The liquid fabric care composition may include additional adjunct materials. Such adjunct materials may include: surfactants, builders, dye transfer inhibiting agents, dispersants, suds suppressors, dyes, additional perfumes and perfume delivery systems, fabric softeners, hydrotropes, processing aids, stabilizers and thickeners, structurants, anti-agglomeration agents. The precise nature of these additional components, and levels of incorporation thereof, will depend on the physical form of the composition and the nature of the operation for which it is to be used. However, when one or more adjuncts are present, such one or more adjuncts may be present as detailed below. The following is a non-limiting list of suitable additional adjuncts.

Surfactants—Surfactants utilized can be of the anionic, nonionic, zwitterionic, ampholytic or cationic type or can comprise compatible mixtures of these types. Anionic and nonionic surfactants are typically employed if the fabric care product is a laundry detergent. On the other hand, cationic surfactants are typically employed if the fabric care product is a fabric softener. In addition to the anionic surfactant, the fabric care compositions of the present invention may further contain a nonionic surfactant.

Specific, non-limiting examples of suitable anionic surfactants include any conventional anionic surfactant. This may include a sulfate detersive surfactant, for e.g., alkoxylated and/or non-alkoxylated alkyl sulfate materials, and/or sulfonic detersive surfactants, e.g., alkyl benzene sulfonates.

Alkoxylated alkyl sulfate materials comprise ethoxylated alkyl sulfate surfactants, also known as alkyl ether sulfates or alkyl polyethoxylate sulfates. Examples of ethoxylated alkyl sulfates include water-soluble salts, particularly the alkali metal, ammonium and alkylolammonium salts, of organic sulfuric compounds having in their molecular structure an alkyl group containing from about 8 to about 30 carbon atoms and a sulfonic acid and its salts. (Included in the term “alkyl” is the alkyl portion of acyl groups. In some examples, the alkyl group contains from about 15 carbon atoms to about 30 carbon atoms. In other examples, the alkyl ether sulfate surfactant may be a mixture of alkyl ether sulfates, said mixture having an average (arithmetic mean) carbon chain length within the range of about 12 to 30 carbon atoms, and in some examples an average carbon chain length of about 12-15 carbon atoms, and an average (arithmetic mean) degree of ethoxylation of from about 1 mol to 4 mols of ethylene oxide, and in some examples an average (arithmetic mean) degree of ethoxylation of about 1.8 mols to about 4 mols of ethylene oxide. In further examples, the alkyl ether sulfate surfactant may have a carbon chain length between about 10 carbon atoms to about 18 carbon atoms, and a degree of ethoxylation of from about 1 to about 6 mols of ethylene oxide. In yet further examples, the alkyl ether sulfate surfactant may contain a peaked ethoxylate distribution,

Non-ethoxylated alkyl sulfates may also be added to the disclosed cleaning compositions and used as an anionic surfactant component. Examples of non-alkoxylated, e.g., non-ethoxylated, alkyl sulfate surfactants include those produced by the sulfation of higher C₈-C₂₀ fatty alcohols. In some examples, primary alkyl sulfate surfactants have the general formula: ROSO₃⁻ M⁺, wherein R is typically a linear Cs-C₂₀ hydrocarbyl group, which may be straight chain or branched chain, and M is a water-solubilizing cation. In some examples, R is a C₁₀-C₁₅ alkyl, and M is an alkali metal. In other examples, R is a C₁₂-C₁₄ alkyl and M is sodium.

Other useful anionic surfactants can include the alkali metal salts of alkyl benzene sulfonates, in which the alkyl group contains from about 9 to about 15 carbon atoms, in straight chain (linear) or branched chain configuration. In some examples, the alkyl group is linear. Such linear alkylbenzene sulfonates are known as “LAS.” In other examples, the linear alkylbenzene sulfonate may have an average number of carbon atoms in the alkyl group of from about 11 to 14. In a specific example, the linear straight chain alkyl benzene sulfonates may have an average number of carbon atoms in the alkyl group of about 11.8 carbon atoms, which may be abbreviated as C11.8 LAS.

Suitable alkyl benzene sulphonate (LAS) may be obtained, by sulphonating commercially available linear alkyl benzene (LAB); suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic detersive surfactant is alkyl benzene sulphonate that is obtained by DETAL catalyzed process, although other synthesis routes, such as HF, may also be suitable. In one aspect a magnesium salt of LAS is used.

The detersive surfactant may be a mid-chain branched detersive surfactant, in one aspect, a mid-chain branched anionic detersive surfactant, in one aspect, a mid-chain branched alkyl sulphate and/or a mid-chain branched alkyl benzene sulphonate, for example, a mid-chain branched alkyl sulphate. In one aspect, the mid-chain branches are Ci-4 alkyl groups, typically methyl and/or ethyl groups.

The compositions of the present invention can contain up to about 50%, alternatively from about 0.01% to about 25%, more alternatively from about 0.1% to about 20%, by weight of the composition, of an anionic surfactant.

The compositions of the present invention can contain up to about 30%, alternatively from about 0.01% to about 20%, more alternatively from about 0.1% to about 10%, by weight of the composition, of a nonionic surfactant. In one embodiment, the nonionic surfactant may comprise an ethoxylated nonionic surfactant. Suitable for use herein are the ethoxylated alcohols and ethoxylated alkyl phenols of the formula R(OC₂H₄)n OH, wherein R is selected from the group consisting of aliphatic hydrocarbon radicals containing from about 8 to about 20 carbon atoms and alkyl phenyl radicals in which the alkyl groups contain from about 8 to about 12 carbon atoms, and the average value of n is from about 5 to about 15.

The fabric care compositions of the present invention may contain up to about 30%, alternatively from about 0.01% to about 20%, more alternatively from about 0.1% to about 20%, by weight of the composition, of a cationic surfactant. For the purposes of the present invention, cationic surfactants include those which can deliver fabric care benefits. Non-limiting examples of useful cationic surfactants include: fatty amines, imidazoline quat materials and quaternary ammonium surfactants, preferably N, N-bis(stearoyl-oxy-ethyl) N,N-dimethyl ammonium chloride, N,N-bis(tallowoyl-oxy-ethyl) N,N-dimethyl ammonium chloride, N,N-bis(stearoyl-oxy-ethyl) N-(2 hydroxyethyl) N-methyl ammonium methylsulfate; 1,2 di (stearoyl-oxy) 3 trimethyl ammoniumpropane chloride; dialkylenedimethylammonium salts such as dicanoladimethylammonium chloride, di(hard)tallowdimethylammonium chloride dicanoladimethylammonium methylsulfate; 1-methyl-1-stearoylamidoethyl-2-stearoylimidazolinium methylsulfate; 1 -tallowylamidoethyl-2-tallowylimidazoline; N,N″-dialkyldiethylenetriamine; the reaction product of N-(2-hydroxyethyl)-1,2-ethylenediamine or N-(2-hydroxyisopropyl)-1,2-ethylenediamine with glycolic acid, esterified with fatty acid, where the fatty acid is (hydrogenated) tallow fatty acid, palm fatty acid, hydrogenated palm fatty acid, oleic acid, rapeseed fatty acid, hydrogenated rapeseed fatty acid; polyglycerol esters (PGEs), oily sugar derivatives, and wax emulsions and a mixture of the above.

It will be understood that combinations of softener actives disclosed above are suitable for use herein.

Builders—The compositions may also contain from about 0.1% to 80% by weight of a builder. Compositions in liquid form generally contain from about 1% to 10% by weight of the builder component. Detergent builders are well known in the art and can contain, for example, phosphate salts as well as various organic and inorganic nonphosphorus builders. Water-soluble, nonphosphorus organic builders useful herein include the various alkali metal, ammonium and substituted ammonium polyacetates, carboxylates, polycarboxylates and polyhydroxy sulfonates. Examples of polyacetate and polycarboxylate builders are the sodium, potassium, lithium, ammonium and substituted ammonium salts of ethylene diamine tetraacetic acid, nitrilotriacetic acid, oxydisuccinic acid, mellitic acid, benzene polycarboxylic acids, and citric acid. Other polycarboxylate builders are the oxydisuccinates and the ether carboxylate builder compositions comprising a combination of tartrate monosuccinate and tartrate disuccinate. Builders for use in liquid detergents include citric acid.

Dispersants—The compositions may contain from about 0.1%, to about 10%, by weight of dispersants. Suitable dispersants are water-soluble homo- or co-polymeric carboxylic acids or their salts, in which the polycarboxylic acid may contain at least two carboxyl radicals separated from each other by not more than two carbon atoms. The dispersants may also be alkoxylated derivatives of polyamines, and/or quaternized derivatives.

Dye Transfer Inhibiting Agents—The compositions may also include from about 0.0001%, from about 0.01%, from about 0.05% by weight of the compositions to about 10%, about 2%, or even about 1% by weight of the compositions of one or more dye transfer inhibiting agents such as polyvinylpyrrolidone polymers, polyamine N-oxide polymers, copolymers of N-vinylpyrrolidone and N-vinylimidazole, polyvinyloxazolidones and polyvinylimidazoles or mixtures thereof.

Stabilizer—The compositions may contain one or more stabilizers and/or thickeners. Any suitable level of stabilizer may be of use; exemplary levels include from about 0.01% to about 20%, from about 0.1% to about 10%, or from about 0.1% to about 3% by weight of the composition. Non-limiting examples of stabilizers suitable for use herein include crystalline, hydroxyl-containing stabilizing agents, trihydroxystearin, hydrogenated castor oil, or a variation thereof, and combinations thereof. In some aspects, the crystalline, hydroxyl-containing stabilizing agents may be water-insoluble wax-like substances, including fatty acid, fatty ester or fatty soap. In other aspects, the crystalline, hydroxyl-containing stabilizing agents may be derivatives of castor oil, such as hydrogenated castor oil derivatives, for example, castor wax. Other stabilizers include thickening stabilizers such as gums and other similar polysaccharides, for example gellan gum, carrageenan gum, and other known types of thickeners and rheological additives. Exemplary stabilizers in this class include gum-type polymers (e.g. xanthan gum) and derivatives thereof, cellulose and derivatives thereof including cellulose ethers and cellulose esters and tamarind gum (for example, comprising xyloglucan polymers), guar gum, locust bean gum (in some aspects comprising galactomannan polymers), and other industrial gums and polymers.

Other examples of suitable stabilizers may include hydrogenated and non-hydrogenated polyalkenes, and mixtures thereof; inorganic salts, for example, magnesium chloride, calcium chloride, calcium formate, magnesium formate, aluminum chloride, laponite clay, bentonite clay and mixtures thereof; polysaccharides in combination with inorganic salts; quaternized polymeric materials, for example, polyether amines, alkyl trimethyl ammonium chlorides, diester ditallow ammonium chloride; imidazoles; nonionic polymers with a pKa less than 6.0, for example polyethyleneimine, polyethyleneimine ethoxylate; polyurethanes. Such materials can be obtained from CP Kelco Corp. of San Diego, Calif. USA; Degussa AG or Dusseldorf, Germany; BASF AG of Ludwigshafen, Germany; Rhodia Corp. of Cranbury, N.J., USA; Baker Hughes Corp. of Houston, Tex., USA; Hercules Corp. of Wilmington, Del., USA; Agrium Inc. of Calgary, Alberta, Canada, ISP of N.J., U.S.A.

Silicones—table silicones comprise Si—O moieties and may be selected from (a) non-functionalized siloxane polymers, (b) functionalized siloxane polymers, and combinations thereof. The molecular weight of the organosilicone is usually indicated by the reference to the viscosity of the material. In one aspect, the organosilicones may comprise a viscosity of from about 10 to about 2,000,000 centistokes at 25° C. In another aspect, suitable organosilicones may have a viscosity of from about 10 to about 800,000 centistokes at 25° C.

Suitable organosilicones may be linear, branched or cross-linked.

In one aspect, the organosilicone may comprise a cyclic silicone. The cyclic silicone may comprise a cyclomethicone of the formula [(CH₃)₂SiO]ₙ where n is an integer that may range from about 3 to about 7, or from about 5 to about 6.

In one aspect, the organosilicone may comprise a functionalized siloxane polymer.

Functionalized siloxane polymers may comprise one or more functional moieties selected from the group consisting of amino, amido, alkoxy, hydroxy, polyether, carboxy, hydride, mercapto, sulfate phosphate, and/or quaternary ammonium moieties. These moieties may be attached directly to the siloxane backbone through a bivalent alkylene radical, (i.e., “pendant”) or may be part of the backbone. Suitable functionalized siloxane polymers include materials selected from the group consisting of aminosilicones, amidosilicones, silicone polyethers, silicone-urethane polymers, quaternary ABn silicones, amino ABn silicones, and combinations thereof.

In one aspect, the functionalized siloxane polymer may comprise a silicone polyether, also referred to as “dimethicone copolyol.” In general, silicone polyethers comprise a polydimethylsiloxane backbone with one or more polyoxyalkylene chains. The polyoxyalkylene moieties may be incorporated in the polymer as pendent chains or as terminal blocks. In another aspect, the functionalized siloxane polymer may comprise an aminosilicone.

In one aspect, the organosilicone may comprise amine ABn silicones and quat ABn silicones. Such organosilicones are generally produced by reacting a diamine with an epoxide.

In another aspect, the functionalized siloxane polymer may comprise silicone-urethanes. These are commercially available from Wacker Silicones under the trade name SLM-21200®.

Compositions according to the present invention may be used to provide a pleasant smell to treated fabrics.

### Methods

### Method of Making a Liquid Fabric Care Composition

The liquid fabric care composition can be obtained by a process comprising the steps of preparing an aqueous salt solution; preparing a perfume solution by mixing a perfume with an alcohol; preparing a polymer solution by mixing a polymer with water; preparing an aggregate dispersion by adding the polymer solution to the salt solution; and mixing the aggregate dispersion with the perfume solution. Adjunct materials may be added in an intermediate step or as a last step. The step of mixing the aggregate dispersion with the perfume solution results in the formation of perfume delivery aggregates in the liquid fabric care composition.

### Washing Procedure

The washing procedure in small scale washing setup (Roaches® Washtec Launder-o-Meter) comprises different steps:
1) A 5 cm×5 cm piece of fabric (cotton or polyester) is weighed (about 0.8 g for cotton and 0.4 g for polyester) and put into the metal Launder-o-Meter jar;
2) 10 metal spheres (stainless steel, mass 2 g, diameter 7 mm) are added into the jar to facilitate mixing;
3) 200 mL of demi water is added to the jar;
4) Unless otherwise mentioned, 1.0-1.1 g of an unperfumed detergent composition is added into the jar;
5) 5 g of the liquid fabric care composition is added to the jar;
6) The jar is closed and placed into the Lauder-o-Meter;
7) The temperature is controlled to 37-38° C.;
8) After 1 hour, the jar is removed from the Launder-o-Meter;
9) The wet fabrics are squeezed to remove excees water by applying the same pressure to obtain the same weight of the different wet fabrics;
10) The jar and the metal spheres are rinsed with demineralized water;
11) The washed fabric is put into the jar again together with the metal spheres;
12) 200 mL of demineralized water are poured;
13) The jars are closed and placed into the Launder-o-Meter;
14) The temperature is set to be 37-38° C.;
15) After 5 minutes, the jar is removed from the Launder-o-Meter;

16) The fabric is squeezed by applying the same pressure to obtain the same wet weight;
17) The wet fabric is placed into a vial for GC-MS head space analysis and the vial is closed.

### Headspace Analysis Through Gas Chromatography—Mass Spectroscopy (GC-MS)

For each fabric sample a specific ion chromatogram is recorded.

For Linalool, the characteristic m/z value of 121 is chosen. After obtaining the extracted ion chromatogram, the signals at retention times corresponding to 5.68 min and 5.72 min are integrated and the sum of the correlation areas obtained from the integration is related to the PRM concentration in the head space.

For Coreamber, the characteristic m/z value of 228 is chosen. After obtaining the extracted ion chromatogram, the signals at 4 different retention times corresponding to 9.30, 9.35, 9.58 and 9.63 min are integrated and the sum of their correlation areas obtained from the integration is related to the PRM concentration in the head space.

The correlation area is normalized by the mass of fabric and the mass of inventive or comparative liquid fabric care composition used in the washing step. The normalized values obtained for the comparative sample (without polymer) and the inventive sample (with polymer) are compared through according to the below equation:

$$Relative difference \% = ( 1 - \frac{normalized area of comparative sample}{normalized area of inventive sample} ) * 100 \%$$

### Method for Determining Viscosity

Viscosity is measured using a controlled stress rheometer (such as an HAAKE MARS from Thermo Scientific, or equivalent), using a 60 mm parallel plate and a gap size of 500 microns at 20° C. The viscosity is obtained by measuring quasi steady state shear stress as a function at a shear rate of 10 s⁻¹. Quasi-steady state is defined as the shear stress value once variation of shear stress over time is less than 3%, after at least 30 seconds and a maximum of 60 seconds at a given shear rate. If after 60 seconds measurement the shear stress value varies more than 3%, the final shear stress measurement is defined as the quasi state value for calculation purposes. The viscosity of the liquid fabric care composition is defined as the measured shear stress divided by the applied shear rate of 10 s⁻¹ at 20° C.

### Static Light Scattering (SLS) Method for Determining Weight Average Molecular Weight

SLS measurements were performed by using a home-made instrument composed by a Photocor compact goniometer, a SMD 6000 Laser Quantum 50 mW light source operating at 5325 Å, a photomultiplier (PMT-120-OP/B) and a correlator (Flex02-01D) from Correlator.com. All measurements were performed at (25.00±0.05) ° C. with the temperature controlled using a thermostat bath.

The weight average molecular weight of polymer is determined by collecting the values of scattering intensities at different polymer concentrations. The relation between the scattering intensity and both concentration and scattering angle is shown in eqn (a):

$$\frac{Kc}{{R}_{θ}} = \frac{1}{{M}_{w}} [ 1 + \frac{{q}^{2} 〈 {R}_{g}^{2} 〉}{3} + 2 {A}_{2} {M}_{w} c ] \qquad eqn ( a )$$

where c is the polymer concentration and

$$K = \frac{1}{{N}_{A}} {( \frac{2 π n}{{λ}^{2}} \frac{dn}{d c} )}^{2}$$

is a term that depends on the incident wavelength λ, the variation of the refractive index with the polymer concentration dn/dc, the Avogadro number N_{A} and the scattering properties of the solvent, i.e. the solvent refractive index n. The parameter q=4πn sin (θ/2)/λ is the modulus of the scattering vector. M_{w}, R_{g} and A₂ are the mass average molecular weight, the radius of gyration and the second virial coefficient, respectively. Finally, R_{θ}is the Rayleigh ratio and it represents the term of the equation where the scattering intensity appears. Its expression is:

$${R}_{θ} = \frac{( {I}_{S} - {I}_{0} )}{{I}_{R}} \frac{{n}_{0}^{2}}{{n}_{R}^{2}} {R}_{θ , R} \qquad eqn ( b )$$

where Iₛ, I₀ and I_{R} are the scattering intensities of the sample, the solvent and the reference (toluene), respectively, no is the refractive index of the solvent, n_{R} is the refractive index of the reference and R_{θ, R} is the Rayleigh ratio of the reference at the same incident wavelength, calculated by applying the following relation:

$${R}_{θ , R} = \frac{2 \cdot ( 4.90 \cdot {10}^{6} ) \cdot {λ}^{- 4.17}}{( 1 + {ρ}_{u} )} \qquad eqn ( c )$$

where λ is the incident wavelength and p, is the depolarization factor for non-polarized light, which was calculated by considering an average value from those already reported in literature for different wavelengths. In the case of small particles with a dimension d<λ/10, the angular contribution to the scattering intensity is neglected, i.e. the scattering object can be represented as a point and, therefore, the constructive/destructive interference arising from the optical path difference can be considered null. Eqn (a) can be modified so as to obtain eqn (d):

$$\frac{Kc}{{R}_{θ}} = \frac{1}{{M}_{w}} + 2 {A}_{2} c \qquad eqn ( d )$$

A linear fit of the experimental data is performed using eqn (d) to obtain the molecular weight from the intercept.

### EXAMPLES

Liquid fabric care compositions comprising perfume delivery aggregates were prepared by providing the following materials:

| Material | Supplier |
|---|---|
| Polyvinyl alcohol (PVA) ^{a} | SIGMA ALDRICH |
| Polyethylene vinyl alcohol (EVOH) - HR3010 ^{b} | KURARAY |
| NaCl | SIGMA ALDRICH |
| Linalool^{c} | SIGMA ALDRICH |
| 1-(2-tert-butylcyclohexyl)oxybutan-2-ol | IFF BENICARLO |
| (CoreAmber)^{c} | |
| Ethanol | ALCODIS |

^{a} >99% hydrolyzed, weight average molecular weight as determined by SLS was 113,000 g/mol
^{b} Degree of hydrolysis is 99.0-99.4%, weight average molecular weight as determined by SLS was 32,000 g/mol
^{c}Linalool and Core Amber are PRM's

A stock NaCl solution was prepared by adding NaCl and water into a glass vial.

A stock PRM (linalool or CoreAmber) solution was prepared by adding the PRM and ethanol into a glass vial.

A polymer (PVA or EVOH) solution was prepared by the steps:
1. Polymer and water were added into a glass vial.
2. The vial was placed into a controlled temperature bath at 85° C. The solution was kept under stirring at 700 rpm using IKA® Magnetic Stirrer Hot Plate RCT classic;
3. After 4 hours the heating and the stirring were stopped and the solution was kept at room temperature (about 20° C.) for 1 hour;
4. The solution was centrifuged for 10 minutes at 4000 rpm in order to precipitate the non-solubilized polymer.

To avoid the presence of dust particles, the NaCl solution and PRM solution were filtered using a 0.2 μm cellulose acetate filter.

Next, the polymer solution was mixed with the NaCl solution and demineralized water by stirring at 1200 rpm. After removing the stirring, the polymer-NaCl mixture was stored at room temperature (about 20° C.) for 4 hours. After the formation of PVA or EVOH aggregates obtained through salting-out, the PRM solution was added. Stirring was stopped and the liquid fabric care compositions comprising perfume delivery aggregates were stored at room temperature. The compositions of the four liquid fabric care compositions comprising perfume delivery aggregates of the present invention (ex. 1 to 4) are disclosed in Table 1. Using the same process but without the addition of PVA or EVOH, four additional comparative compositions (ex. 5-8) were also prepared and disclosed in Table 1.

TABLE 1
Composition of examples 1 to 8. Comparative examples are indicated with an
asterisk. All examples 1 to 8 were liquid and had a viscosity of less than 10 Pa · s.

| | Ex. 1 | Ex. 2 | Ex. 3 | Ex. 4 | Ex. 5* | Ex. 6* | Ex. 7* | Ex. 8* |
|---|---|---|---|---|---|---|---|---|
| | Weight % | | | | | | | |
| Water | Balance to 100% | | | | | | | |
| NaCl | 10.5% | 8.12% | 4.76% | 4.76% | 10.5% | 8.12% | 4.76% | 4.76% |
| PVA | 0.85% | 0.925% | — | — | — | — | — | — |
| EVOH | — | — | 0.85% | 0.925% | — | — | — | — |
| Ethanol | 20% | 30% | 20% | 30% | 20% | 30% | 20% | 30% |
| Linalool | 0.15% | — | 0.15% | — | 0.15% | — | 0.15% | — |
| CoreAmber | — | 0.075% | — | 0.075% | — | 0.075% | — | 0.075% |

Fabrics were treated with the different liquid fabric care compositions Ex. 1-8 from Table 1 using a Launder-o-Meter (small scale laundry machine). Each composition was tested in 8 different jars in the Lauder-o-Meter. The same procedure was carried out for both cotton and polyester fabrics, washed in two separate experiments.

Table 2 summarizes the results of the headspace analysis for fabrics treated with inventive compositions ex.1 to 4 as compared relative to the headspace analysis of fabrics treated with comparative compositions ex. 5-8, respectively. A higher headspace concentration above wet treated fabrics is indicative of improved deposition and/or release of perfume. The error on the measurements is the standard deviation from 3 independent headspace measures.

TABLE 2
Relative headspace concentration above wet fabrics
treated with inventive compositions ex. 1 to 4 as
compared to comparative compositions ex. 5 to 8.

| | Ex. 1 vs Ex. | Ex. 2 vs Ex. | Ex. 3 vs Ex. | Ex. 4 vs Ex. |
|---|---|---|---|---|
| Fabric type | 5 | 6 | 7 | 8 |
| Cotton | +13 ± 1% | +8 ± 1% | +3 ± 0.6% | +10.4 ± 0.4% |
| Polyester | +4 ± 1% | +7 ± 1% | +17 ± 2% | +16 ± 1% |

By comparing ex. 1 with ex. 5, ex. 2 with ex. 6, ex. 3 with ex. 7, ex. 4 with ex. 8, it is clear that the inventive compositions (ex. 1-4) resulted consistently in a higher headspace PRM concentration above treated wet fabrics.

Inventive composition ex. 1 and comparative ex. 5 were each blended with a detergent compostion resulting in inventive composition ex. 9 and comparative composition ex. 10, respectively (Table 3).

TABLE 3
Composition of inventive liquid fabric care composition ex. 9 and
comparative liquid fabric care composition ex. 10. Examples 9 and
10 were liquid and had a viscosity of less than 10 Pa · s.

| | Ex. 9 | Ex. 10* |
|---|---|---|
| | Weight % | |
| Poly(oxy-1,2-ethanediyl), alpha-sulfo-omega- | 0.17 | |
| hydroxy-, C10-16-alkyl ethers, sodium salts | | |
| 98% wt. Benzenesulfonic acid, 4-C10-13-sec- | 1.42 | |
| alkyl derivs // 2% wt. sulfuric acid | | |
| Mixture of linear (C12 and C14) alkyl alcohols, | 0.28 | |
| ethoxylated (3, 5, 7, 9 or 12 average ethoxylic | | |
| units) | | |
| (C10-C16)Alkylalcohol, ethoxylate (1 average | 0.57 | |
| ethoxylic unit) | | |
| Palm Kernel Oil Fatty Acids | 0.36 | |
| Citric Acid | 0.44 | |
| 26% wt Phosphonic acid, | 0.063 | |
| [[(phosphonomethyl)imino]bis | | |
| [2,1-ethanediylnitrilobis(methylene)]]tetrakis-, | | |
| sodium salt // 50% wt. Formaldehyde // 8% NaCl | | |
| Amylase | 0.0005 | |
| Pectate Lyase | 0.0003 | |
| Mannanase | 0.0002 | |
| Protease | 0.0030 | |
| Calcium chloride | 0.0014 | |
| Sodium formate | 0.0040 | |
| Hexamethylene diamine, ethoxylated, quaternized, | 0.088 | |
| sulfated | | |
| PEG-PVAc polymer | 0.15 | |
| Fluorescent Whitening Agent 49 | 0.0070 | |
| 80% wt. 1,2-Benzisothiazol-3(2H)-one // 20% wt. | 0.0007 | |
| 3(2H)-Isothiazolone, 2-methyl- | | |
| 1,2 Propanediol | 0.16 | |
| Sodium Cumenesulfonate | 0.063 | |
| Ethanolamine | 0.031 | |
| Sodium Hydroxide | 0.501 | |
| (C10-C16)Alkyl benzenesulfonic acid, monoethano- | 0.039 | |
| lamine salt | | |
| 57% wt. Hydroxyethylcellulose // 43% wt. Treated | 0.0004 | |
| amorphous silica | | |
| Dye | 0.0007 | |
| PVA | 0.73 | — |
| NaCl | 9.0 | 9.0 |
| Linalool | 0.13 | 0.13 |
| Ethanol | 17.3 | 17.3 |

| | |
|---|---|
| Water | Balance to 100% |

Both ex. 9 and ex. 10 were stored for 10 days at room temperature (about 20° C.). After this ageing process, the headspace concentration above wet fabrics treated with the inventive liquid fabric composition ex. 9 relative to the headspace concentration above wet fabrics treated with comparative composition ex. 10 was +10±0.1% on cotton fabric and +3±1% on polyester fabrics. Hence, a consistent higher headspace PRM concentration was obtained above wet treated fabrics with the inventive composition in presence of other adjunct materials.

The effect of polymer concentration on the physical stability of inventive liquid fabric care compositions was evaluated upon storage. The compositions are described in Table 4.

TABLE 4
Inventive liquid fabric care compositions ex. 11 to 13.

| | Ex. 11 | Ex. 12 | Ex. 13 |
|---|---|---|---|
| | Weight % | | |
| Water | Balance to 100% | | |
| NaCl | 10.5% | 10.5% | 10.5% |
| PVA | 0.85% | 0.68% | 0.51% |
| EVOH | 20% | 20% | 20% |
| Ethanol | 0.15% | 0.12% | 0.09% |
| Linalool | 10.5% | 10.5% | 10.5% |

No precipitation or other phase instabilities were observed in Ex. 11 through 13 after 3 months storage at about 20° C.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.
“Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.”
“While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.”

What is claimed is:

1. A liquid fabric care composition obtained by a process comprising the steps of
a. preparing an aqueous salt solution, wherein salt is present at a level of from about 2% to about 25% of by weight of the aqueous salt solution and wherein the salt is selected from a group consisting of alkaline metals salts, alkaline earth metal salts of the mineral acids, and combinations thereof;
b. preparing a perfume solution by mixing a perfume with an alcohol wherein the perfume is present in the perfume solution at a level of from about 0.02% to about 4% by weight of the perfume solution and wherein the alcohol is selected from methanol, ethanol, propanol, and isopropanol;
c. preparing a polymer solution by mixing a polymer with water wherein the polymer is present at a level of from about 0.5% to about 8% by weight of the polymer solution and wherein the polymer is non-crosslinked and the polymer comprises vinylalcohol units;
d. preparing an aggregate dispersion by adding the polymer solution to the salt solution;
e. mixing the aggregate dispersion with the perfume solution;
wherein said salt is present at a level of from about 1% to about 15% by weight of the liquid fabric care composition; wherein said polymer is present at a level of from about 0.1% to about 7.5% by weight of the liquid fabric care composition; wherein the weight average molecular weight of the polymer as determined by Static Light Scattering is from about 10,000 to about 200,000 g/mol; and wherein said perfume is present at a level of from about 0.01% to about 2.0% by weight of the liquid fabric care composition.

2. The liquid fabric care composition according to claim 1, wherein the polymer is polyvinylalcohol or polyethylenevinylalcohol.

3. The liquid fabric care composition according to claim 1, wherein the polymer concentration is from about 0.3% to about 5%, by weight of the liquid fabric care composition.

4. The liquid fabric care composition according to claim 1, wherein the salt comprises a cation and an anion wherein the cation is selected from a list consisting of Li⁺, Na⁺, K⁺Ca²⁺, Mg²⁺; and the anion is selected from a list consisting of Cl⁻, I⁻, Br⁻, SO₄²⁻; preferably the salt is selected from a list consisting of NaCl, KCl, LiCl, CaCl₂, MgCl₂; more preferably the salt is NaCl.

5. The liquid fabric care composition according to claim 1, wherein the salt is present at a level of from about 3% to about 13%, by weight of the liquid fabric care composition.

6. The liquid fabric care composition according to claim 1, wherein the alcohol is ethanol.

7. The liquid fabric care composition according to claim 1, wherein the perfume is present at a level from about 0.03% to about 1%, by weight of the liquid fabric care composition.

8. The liquid fabric care composition according to claim 1, wherein the perfume comprises linalool and/or 1-(2-tert-butylcyclohexyl)oxybutan-2-ol.

9. A process for making a liquid fabric care composition process comprising the steps of
a. preparing an aqueous salt solution, wherein salt is present at a level of from about 2% to about 25% of by weight of the aqueous salt solution and wherein the salt is selected from a group consisting of alkaline metals salts, alkaline earth metal salts of the mineral acids, and combinations thereof;
b. preparing a perfume solution by mixing a perfume with an alcohol wherein the perfume is present in the perfume solution at a level of from about 0.02% to about 4% by weight of the perfume solution and wherein the alcohol comprises from about 1 to about 7 carbons;
c. preparing a polymer solution by mixing a polymer with water wherein the polymer is present at a level of from about 0.5% to about 8% by weight of the polymer solution and wherein the polymer is non-crosslinked and the polymer comprises vinylalcohol units;
d. preparing an aggregate dispersion by adding the polymer solution to the salt solution;
e. mixing the aggregate dispersion with the perfume solution;
f. optionally adding adjunct materials;
wherein said salt is present at a level of from about 1% to about 15% by weight of the liquid fabric care composition; wherein said polymer is present at a level of from about 0.1% to about 7.5% by weight of the liquid fabric care composition; wherein said perfume is present at a level of from about 0.01% to about 2.0% by weight of the liquid fabric care composition.

10. A use of liquid fabric care compositions according to claim 1 to provide a pleasant smell to treated fabrics.
